(19) United States
(12) Patent Application Publication
(10) Pub. No.: US 2026/0162011 A1
(43) Pub. Date: Jun. 11, 2026

(54) TRAINING APPARATUS AND TRAINING METHOD

(71) Applicant: NEC Corporation, Tokyo (JP)

(72) Inventor: Kazutoshi HIROSE, Tokyo (JP)

(73) Assignee: NEC Corporation, Tokyo (JP)

(21) Appl. No.: 19/386,513

(22) Filed: Nov. 12, 2025

(30) Foreign Application Priority Data
Dec. 9, 2024 (JP) 2024-214089

(51) Int. Cl. G06N 20/00

(52) U.S. Cl. CPC G06N 20/00

(57) ABSTRACT

Even when using early fusion, to suppress a decrease in inference accuracy, the training apparatus includes a training unit which train models each corresponding to each of a plurality of types of input data, using each of the plurality of types of input data, and a model averaging unit which calculates an average value of the parameters of the trained models.

### CROSS-REFERENCE TO RELATED APPLICATION

This application is based upon and claims the benefit of priority from the Japanese Patent Application No. 2024-214089 filed on Dec. 9, 2024, the entire disclosure of which is hereby incorporated.

### BACKGROUND OF THE INVENTION

### Technical Field

The present disclosure relates to a training apparatus and a training method related to multimodal machine learning.

### Description of the Related Art

As a method of neural network inference, there is multimodal processing that handles multiple types of input data simultaneously. When multimodal processing is used, by integrally processing multiple input data, inference accuracy can be improved.

As representative schemes related to integration of input data, there are early fusion and late fusion. Early fusion is a scheme in which multiple input data are combined before inference by a neural network is executed.

### CITATION LIST

### Patent Literature

[Patent literature 1] Japanese Patent Application Publication No. 2023-79138

### Non-Patent Literature

[Non patent literature 1] Chi Thang Duong, et al., “Multimodal Classification for Analysing Social Media”, Aug. 7, 2017, Computer Science

### SUMMARY OF THE INVENTION

When early fusion is used, the computational cost is reduced compared with late fusion which is high in accuracy but requires a large computational cost. That is, late fusion is a scheme in which data are integrated after inference by a neural network is executed.

When early fusion is used, it is necessary to equalize the sizes of multiple input data. The size of input data can be represented by channel, height, and width. Equalizing the sizes of multiple input data specifically means making at least any two of channel, height, and width equal to the same values. Hereinafter, each of channel, height, and width may be referred to as a dimension.

For example, when multiple input data are given in which both height and width, or either one of them, differ, in order to equalize the sizes of the multiple input data, it is required to enlarge or reduce the input data.

Then, when early fusion is used, a loss of information may occur and the inference accuracy may deteriorate.

Patent literature 1 describes combining input data in the machine learning field. Patent literature 1 also describes a method of applying a predetermined transformation process (pre-processing) to input data and inputting the preprocessed input data to a training apparatus. Non-patent literature 1 proposes Joint fusion and Common space fusion as multimodal approaches, in addition to early fusion and late fusion.

The object of the present invention is to provide a training apparatus, a training method, and a training program that can suppress decrease in inference accuracy even when using early fusion.

The training apparatus according to the present disclosure includes training means for training models each corresponding to each of a plurality of types of input data, using each of the plurality of types of input data, and model averaging means for calculating an average value of the parameters of the trained models.

The training method according to the present disclosure includes training models each corresponding to each of a plurality of types of input data, using each of the plurality of types of input data, and calculating an average value of the parameters of the trained models.

The training program according to the present disclosure causes a computer to execute training models each corresponding to each of a plurality of types of input data, using each of the plurality of types of input data, and calculating an average value of the parameters of the trained models.

According to the present invention, even when using early fusion, decrease in inference accuracy can be suppressed.

### BRIEF DESCRIPTION OF THE DRAWINGS

FIG. 1 It is a block diagram showing an example configuration of the training apparatus.

FIG. 2 It is an explanatory diagram showing an example of input data.

FIG. 3 It is an explanatory diagram showing pre-training.

FIG. 4 It is schematic diagram showing a process of the layer weight combining unit in the model averaging unit.

FIG. 5 It is an explanatory diagram showing a training process using a pre-trained training model.

FIG. 6 It is a flowchart showing an operation of the training apparatus.

FIG. 7 It is a block diagram showing an example configuration of an information processing system.

FIG. 8 It is a block diagram showing the main part of the training apparatus.

### DESCRIPTION OF THE PREFERRED EMBODIMENTS

Hereinafter, an example embodiment of the present disclosure will be explained with reference to the drawings.

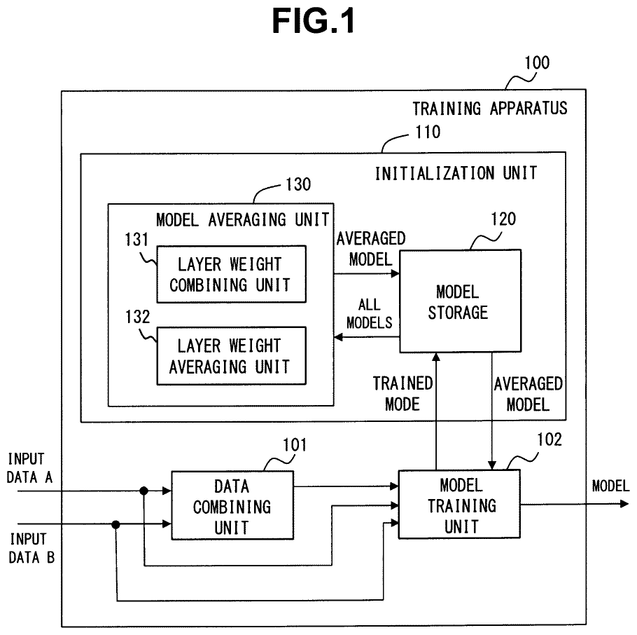

FIG. 1 is a block diagram showing an example configuration of the training apparatus. The training apparatus 100 shown in FIG. 1 comprises an initialization unit 110, a data combining unit 101, and a model training unit 102.

The initialization unit 110 includes a model storage 120 and a model averaging unit 130. The model averaging unit 130 includes a layer weight combining unit 131 and a layer weight averaging unit 132.

The model storage 120 in the initialization unit 110 is a memory that stores trained models. The layer weight combining unit 131 in the model averaging unit 130 reads all models stored in the model storage 120 and combines parameters of a predetermined layer for each model. The layer weight averaging unit 132 in the model averaging unit 130 calculates an average value of the parameters across all models for each layer in the model.

In this example embodiment, the training apparatus 100 performs pre-training before model training to determine initial values of parameters of the model (model parameters). The parameters are primarily weights. The training performed using the initial parameter values determined by pre-training is referred to as main training or a training process.

In the pre-training, the training apparatus 100 performs training on a corresponding model for each of multiple types of input data. Specifically, the model training unit 102 performs both pre-training and main training. Consider a case with two types of input data. When performing pre-training, the model training unit 102 performs training on one type of input data and stores the trained model (corresponding to model A described later) in the model storage 120. Next, the model training unit 102 performs training on the other input data and stores the trained model (corresponding to Model B described later) in the model storage 120.

Then, the training apparatus 100 calculates an average value of the parameters of respective models. The training apparatus 100 uses the average value as the initial value.

It should be noted that during pre-training, the structure of the model trained for each modality is the same as the model structure used in the main training. However, when the number of input data channels during pre-training differs from the number of input data channels during the main training, in the pre-training, a model with a structure in which only the first layer is different from that of the model in the main training is used. For example, when the first layer is a convolutional layer, the number of input channels for the convolutional layer is matched with the number of input data channels.

The pre-training will be explained below using a specific example.

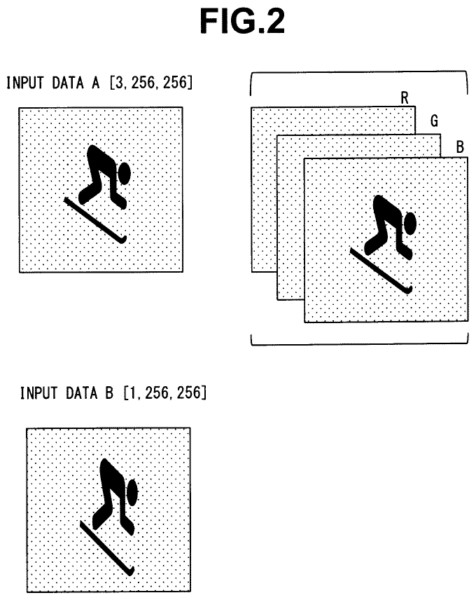

FIG. 2 is an explanatory diagram showing an example of input data. FIG. 2 illustrates two input data sets (input data A, input data B). It should be noted that the number of input data sets is not limited to two; three or more types of input data may be input to the training apparatus 100.

Hereinafter, color image data (hereinafter referred to as a color image) is used as an example for input data A, and monochrome image data (hereinafter referred to as a monochrome image) is used as an example for input data B. That is, input data A and input data B share the same image type but differ in format. However, input data A and input data B may be of the same format (in this example, either color image or monochrome image). Further, input data to the training apparatus 100 is not limited to image data. For example, the input data may be audio data, text data, wireless signals, etc.

The number of channels, height, and width of input data are expressed as [number of channels, height, width]. Input data may also be referred to as a modality.

In the example shown in FIG. 2, the number of channels, height, and width of input data A are [3, 256, 256]. The number of channels, height, and width of input data B are [1, 256, 256].

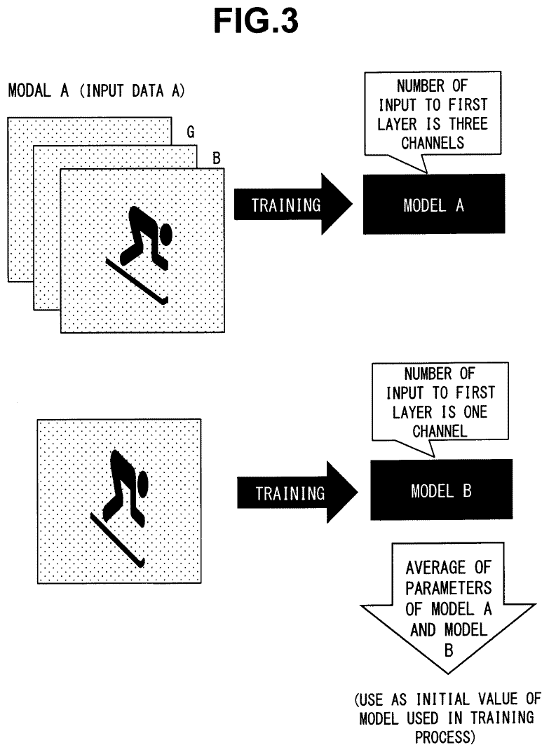

FIG. 3 is an explanatory diagram for explaining pre-training. FIG. 3 illustrates Model (modality) A as an example of a model corresponding to Modal A (input data A). Model B is illustrated as an example of a model corresponding to Modal B (input data B).

The structure of the models trained in each model is the same as the structure of the models in the main training. However, when the number of channels in a modality in the main training differs from the number of channels in Modals A and B, Models A and B use models whose structure differs from the model in the main training only in the first layer.

Taking a convolutional neural network (CNN) as an example model, when the first layer is a convolutional layer, the number of input channels for the convolutional layer is matched with the number of channels in the input data. For Modals A and B illustrated in FIG. 2, the number of input channels for Modal A is 3. The number of input channels for Modal B is 1.

The training apparatus 100 calculates an average value between the parameters of model A and the corresponding parameters of model B. When there are multiple parameters, the training apparatus 100 calculates an average value for each parameter. As described above, the average value is used as an initial value in the training process. In the training apparatus 100, each model for which pre-training is completed is stored in the model storage 120.

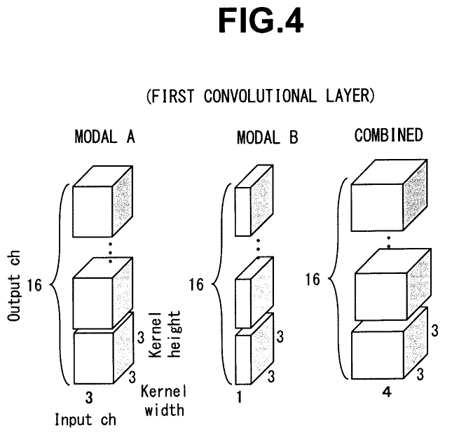

FIG. 4 is a schematic diagram for explaining the process performed by the layer weight combining unit 131 in the model averaging unit 130. FIG. 4 schematically shows the parameters of the first convolutional layer as cubes corresponding to each output channel. FIG. 4 illustrates the number of output channels (Output ch), the number of input channels (Input ch), kernel height (number of rows), and kernel width (number of columns) of the first layer in the convolutional layer of Modal A (input data A) and Modal B (input data B). In the example shown in FIG. 4, the number of output channels, the number of input channels, the kernel height, and the kernel width of the first layer of Modal A are (16, 3, 3, 3). The number of output channels, the number of input channels, the kernel height, and the kernel width of the first layer of Modal B are (16, 1, 3, 3).

The number of input channels in the parameters corresponds to the number of channels in each input data. In the example shown in FIG. 4, the number of input channels is 3 for Modal A and 1 for Modal B. The layer weight combining unit 131 in the model averaging unit 130 combines the parameters of Modal A with the parameters of Modal B. In the example shown in FIG. 4, the layer weight combining unit 131 combines the parameters of Modal A and Modal B along the axis of the input channel dimension. That is, the parameters of Modal A and Modal B are combined in the input channel direction. In the example shown in FIG. 4, the number of output channels, the number of input channels, the kernel height, and the kernel width become (16, 4, 3, 3). By concatenation, the number of input channels of the convolutional layer becomes 4.

The layer weight averaging unit 132 in the model averaging unit 130 calculates an average value for each layer parameter for layers starting from the second layer.

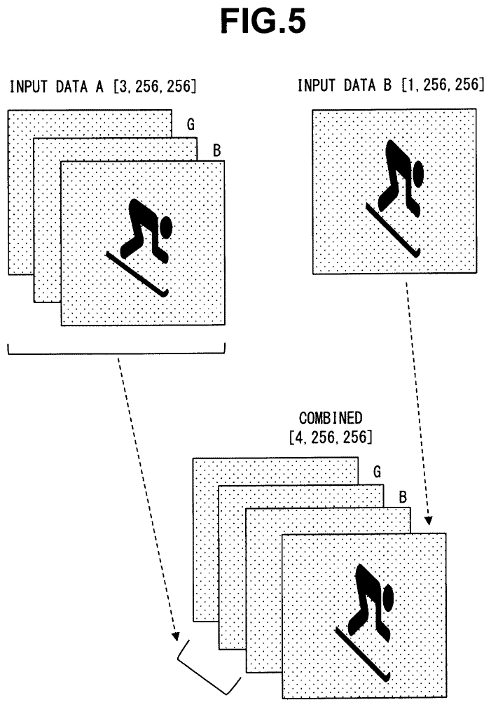

FIG. 5 is an explanatory diagram for explaining the training process (main training) using a pre-trained model. FIG. 5 illustrates multiple input data (input data A and input data B). The number of channels, the height, and the width of input data A are [3, 256, 256]. The number of channels, the height, and the width of input data B are [1, 256, 256].

In the main training, the data combining unit 101 combines multiple input data (for example, input data A and input data B). The data combining unit 101 combines input data A and input data B, for example, in the channel direction. Therefore, the single input data through concatenation has the number of channels, the height, and the width of [4, 256, 256].

The model training unit 102 reads the initial value, namely the average value for each input channel of each layer, from the model storage 120. The model training unit 102 sets the read average value as the parameter for each layer. Subsequently, the model is trained sequentially using the combined single input data from the multiple input data (for example, input data A and input data B) that are input sequentially.

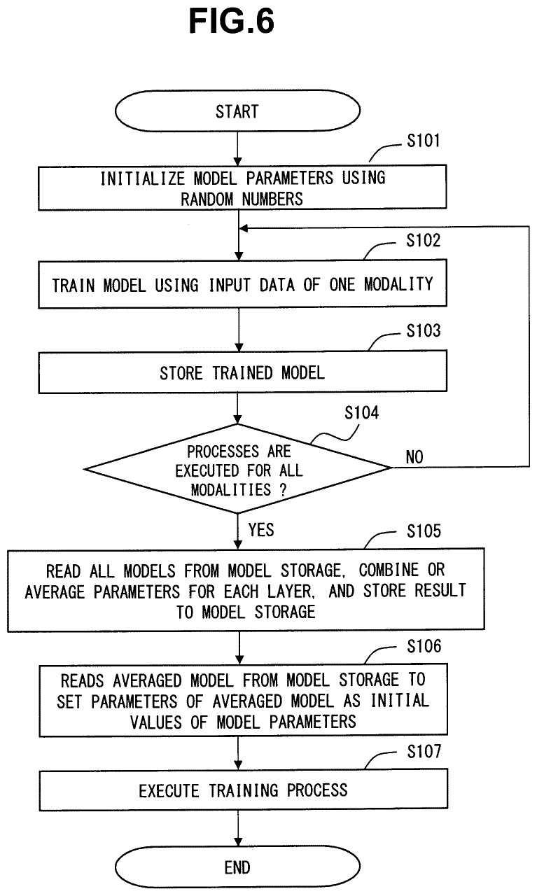

Next, the operation of the training apparatus 100 will be explained, referring to the flowchart in FIG. 6. The process in steps S101 to S105 is the process during pre-training. The process in steps S106 to S107 is the process during main training.

It is preferable that a pre-process be performed before the pre-training process. The pre-process includes normalization, resizing, clipping, inversion, and other processing applied to the input data. Further, in the pre-process, data of all modalities are made to have the same size (for example, the same height and width) with respect to the dimension of the direction of concatenation (for example, the channel).

Although not explicitly shown in FIG. 1, the training apparatus 100 may include a pre-processing unit that performs the aforementioned pre-process.

In the pre-training process, the model training unit 102 first initializes model parameters using random numbers (step S101).

Then, the model training unit 102 trains the model using input data of one modality (step S102). Subsequently, the model training unit 102 stores the trained model in the model storage 120 (step S103). After executing steps S102 and S103 for all modalities (step S104), the process proceeds to step S105.

In step S105, the model averaging unit 130 reads all models from the model storage 120.

Then, the model averaging unit 130 combines or averages the parameters of all models for each layer. Specifically, the layer weight combining unit 131 performs parameter combining for the first layer of the model (see FIG. 4). For each layer from the second layer onwards of the model, the layer weight averaging unit 132 calculates an average value of the parameters corresponding to each input data (parameters in each modality). The model averaging unit 130 then outputs one model whose parameters are set to the average value, to the model storage 120 (step S105). The model storage 120 stores the model.

In the main training, the model training unit 102 reads a model from the model storage 120. Then, the model training unit 102 sets the parameters of the model as the initial values of the model parameters used in the main training (step S106).

Thereafter, the model training unit 102 executes the main training (training process) (step S107).

As described above, when the main training is executed, the data combining unit 101 supplies a single input data generated by combining multiple input data (for example, input data A and input data B) to the model training unit 102. Once training is complete, the model training unit 102 can provide the trained model as a model for actual operation.

Generally, in machine learning, results vary with each training run. Therefore, by generating multiple models under identical condition and averaging their parameters, a stable model will be obtained. In this example embodiment, each model is trained beforehand using input data of each modality. The parameters of each model are averaged, and the average value is used as the initial parameter value for the main training. Then, by training with input data combining multiple modalities in the main training, stable training becomes possible. As a result, even when using early fusion, decrease in inference accuracy can be suppressed.

Therefore, the training apparatus 100 of this example embodiment is expected to provide an effect of improving the accuracy of the model executing inference in machine learning applications using early fusion, for example.

While the above example embodiment may be implemented in hardware, they may also be realized using a computer having a processor such as a CPU (Central Processing Unit) and a memory.

For example, a program for executing the method (processing) described in the above example embodiment may be stored in a storage device (storage medium), and each function may be realized by executing the program stored in the storage device by a CPU.

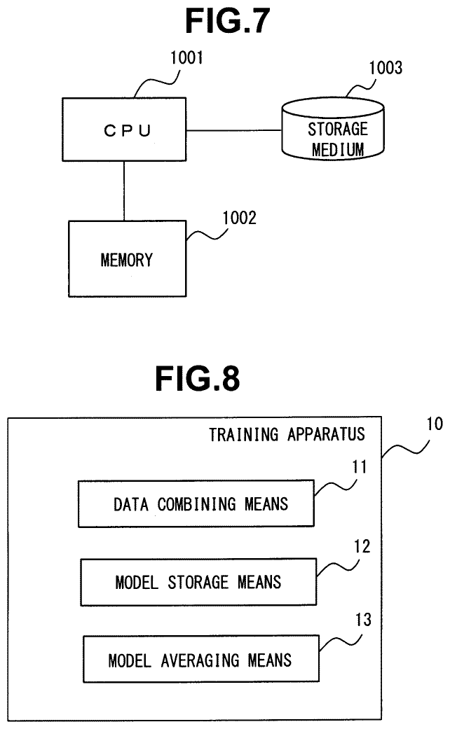

FIG. 7 is a block diagram showing an example of a computer having a CPU. The computer is implemented in the training apparatus 100. The CPU 1001 performs processing according to a program (software element: codes) stored in the storage medium 1003, thereby implementing the functions described in the above example embodiment. Specifically, The CPU 1001 realizes the functions of the data combining unit 101, the model training unit 102, and the model averaging unit 130 in the training apparatus 100 shown in FIG. 1.

Multiple processors (computers) may also cooperate to realize the functions of the training apparatus 100. Further, a CPU and a GPU (Graphics Processing Unit) may cooperate to realize the functions of the training apparatus 100.

The storage medium 1003 is, for example, a non-transitory computer-readable medium. A non-transitory computer-readable medium includes various types of tangible storage media. Specific examples of non-transitory computer-readable media include a magnetic recording medium (for example, hard disk), a magneto-optical recording medium (for example, magneto-optical disk), a CD-ROM (Compact Disc-Read Only Memory), a CD-R (Compact Disc-Recordable), a CD-RW (Compact Disc-ReWritable), and a semiconductor memory (for example, mask ROM, PROM (Programmable ROM), EPROM (Erasable PROM), flash ROM).

The program may also be stored on various types of transitory computer-readable media. Transitory computer-readable media may, for example, be provided through a wired or wireless communication channel, that is, through electrical signals, optical signals, or electromagnetic waves.

For example, a RAM (Random Access Memory) can be used as the memory 1002. The memory 1002 stores temporary data when the CPU 1001 executes processing. It can be assumed that a program held by the storage medium 1003 or a temporary computer-readable medium is transferred to the memory 1002 and the CPU 1001 executes processing based on the program in the memory 1002. The memory 1002 and the storage medium 1003 may be integrated into a single unit

Further, the model storage 120 may be realized by the memory 1002 or the storage medium 1003.

FIG. 8 is a block diagram showing the main part of the training apparatus. The training apparatus 10 shown in FIG. 8 comprises training means (in the example embodiment, realized by the model training unit 102) for training models each corresponding to each of a plurality of types of input data, using each of the plurality of types of input data, and model averaging means (in the example embodiment, realized by the model averaging unit 130) for calculating an average value of the parameters of the trained models.

A part of or all of the above example embodiment may also be described as, but not limited to, the following supplementary notes.

(Supplementary note 1) A training apparatus comprising:
training means for training models each corresponding to each of a plurality of types of input data, using each of the plurality of types of input data, and
model averaging means for calculating an average value of the parameters of the trained models.

(Supplementary note 2) The training apparatus according to Supplementary note 1, further comprising model storage means for storing trained models,
wherein the model averaging means calculates the average value of the parameters of the plural models stored in the model storage means.

(Supplementary note 3) The training apparatus according to Supplementary note 1 or 2, wherein
the model averaging means calculates the average value of the parameters, corresponding to each input data, of all models for each layer of the model having multiple layers.

(Supplementary note 4) The training apparatus according to Supplementary note 3, wherein
the model averaging means combines the parameters corresponding to each input data for the first layer of the model and calculates the average value of the parameters for each layer from the second layer onwards.

(Supplementary note 5) The training apparatus according to any one of Supplementary notes 1 to 4 further comprising data combining means (in the example embodiment, realized by the data combining unit 101) for combining multiple input data into a single data,
wherein the training means re-trains the model using combined single data with the average value of the parameters as the initial value.

(Supplementary note 6) A training method comprising:
training models each corresponding to each of a plurality of types of input data, using each of the plurality of types of input data, and
calculating an average value of the parameters of the trained models.

(Supplementary note 7) The training method according to Supplementary note 6, wherein
the average value of the parameters of the plural models stored in the model storage which stores trained models is calculated.

(Supplementary note 8) The training method according to Supplementary note 6 or 7, wherein
the average value of the parameters, corresponding to each input data, of all models is calculated for each layer of the model having multiple layers.

(Supplementary note 9) The training method according to Supplementary note 8, wherein
the parameters corresponding to each input data for the first layer of the model are combined, and
the average value of the parameters is calculated for each layer from the second layer onwards.

(Supplementary note 10) The training method according to any one of Supplementary notes 6 to 9, wherein
multiple input data is combined into a single data, and
the model is re-trained using combined single data with the average value of the parameters as the initial value.

(Supplementary note 11) A training program causing a computer to execute:
training models each corresponding to each of a plurality of types of input data, using each of the plurality of types of input data, and
calculating an average value of the parameters of the trained models.

(Supplementary note 12) The training program according to Supplementary note 11, causing a computer to execute
calculating the average value of the parameters of the plural models stored in the model storage which stores trained models.

(Supplementary note 13) The training program according to Supplementary note 11 or 12, causing a computer to execute
calculating the average value of the parameters, corresponding to each input data, of all models for each layer of the model having multiple layers.

(Supplementary note 14) The training program according to Supplementary note 13, causing a computer to execute
combining the parameters corresponding to each input data for the first layer of the model are combined, and
calculating the average value of the parameters for each layer from the second layer onwards.

(Supplementary note 15) The training program according to any one of Supplementary notes 11 to 14, causing a computer to execute
combining multiple input data into a single data, and
re-training the model using combined single data with the average value of the parameters as the initial value.

Some or all of the configurations described in Supplementary notes 2 to 5 that directly or indirectly depend on the aforementioned Supplementary note 1 can be applied to various hardware, software, various recording means that record software, or systems, on condition that the above example embodiment are not deviated from.

Although the present disclosure has been described above with reference to example embodiment, the present disclosure is not limited to the above example embodiments. Various changes can be made to the configuration and details of the present disclosure that can be understood by those skilled in the art within the scope of the present disclosure.

What is claimed is:

1. A training apparatus comprising:
a memory storing software instructions; and
one or more processors configured to execute the software instructions to:
train models each corresponding to each of a plurality of types of input data, using each of the plurality of types of input data, and
calculate an average value of the parameters of the trained models.

2. The training apparatus according to claim 1, further comprising model storage which stores trained models,
wherein the one or more processors are configured to execute the software instructions to
calculate the average value of the parameters of the plural models stored in the model storage.

3. The training apparatus according to claim 1, wherein
the one or more processors are configured to execute the software instructions to calculate the average value of the parameters, corresponding to each input data, of all models for each layer of the model having multiple layers.

4. The training apparatus according to claim 2, wherein
the one or more processors are configured to execute the software instructions to calculate the average value of the parameters, corresponding to each input data, of all models for each layer of the model having multiple layers.

5. The training apparatus according to claim 3, wherein
the one or more processors are configured to execute the software instructions to combine the parameters corresponding to each input data for the first layer of the model and calculates the average value of the parameters for each layer from the second layer onwards.

6. The training apparatus according to claim 4, wherein
the one or more processors are configured to execute the software instructions to combine the parameters corresponding to each input data for the first layer of the model and calculates the average value of the parameters for each layer from the second layer onwards.

7. The training apparatus according to claim 1, wherein
the one or more processors are configured to execute the software instructions to combine multiple input data into a single data, and
re-train the model using combined single data with the average value of the parameters as the initial value.

8. The training apparatus according to claim 2, wherein
the one or more processors are configured to execute the software instructions to combine multiple input data into a single data, and
re-train the model using combined single data with the average value of the parameters as the initial value.

9. The training apparatus according to claim 3, wherein
the one or more processors are configured to execute the software instructions to combine multiple input data into a single data, and
re-train the model using combined single data with the average value of the parameters as the initial value.

10. The training apparatus according to claim 4, wherein
the one or more processors are configured to execute the software instructions to combine multiple input data into a single data, and
re-train the model using combined single data with the average value of the parameters as the initial value.

11. The training apparatus according to claim 5, wherein
the one or more processors are configured to execute the software instructions to combine multiple input data into a single data, and
re-train the model using combined single data with the average value of the parameters as the initial value.

12. The training apparatus according to claim 6, wherein
the one or more processors are configured to execute the software instructions to combine multiple input data into a single data, and
re-train the model using combined single data with the average value of the parameters as the initial value.

13. A training method, implemented by a processor, comprising:
training models each corresponding to each of a plurality of types of input data, using each of the plurality of types of input data, and
calculating an average value of the parameters of the trained models.

14. The training method according to claim 13, wherein
multiple input data is combined into a single data, and
the model is re-trained using combined single data with the average value of the parameters as the initial value.

15. A non-transitory computer-readable recording medium storing a training program, wherein the training program causes a computer to execute:
raining models each corresponding to each of a plurality of types of input data, using each of the plurality of types of input data, and
calculating an average value of the parameters of the trained models.

16. The non-transitory computer-readable recording medium according to claim 15, wherein the training program causes the computer to execute:
combining multiple input data into a single data, and
re-training the model using combined single data with the average value of the parameters as the initial value.
